(19) United States
(12) Patent Application Publication
(10) Pub. No.: US 2026/0332872 A1
(43) Pub. Date: Oct. 22, 2026

(54) IMAGING DEVICE AND MONITORING DEVICE

(71) Applicant: MINEBEA MITSUMI Inc., Nagano (JP)

(72) Inventors: Kazuyuki IWAMOTO, Kitasaku-gun (JP); Masahisa NISHIO, Kitasaku-gun (JP); Yasuyuki FUJII, Kitasaku-gun (JP); Takefumi WATANABE, Kitasaku-gun (JP)

(21) Appl. No.: 19/651,402

(22) Filed: Apr. 17, 2026

(30) Foreign Application Priority Data
Apr. 22, 2025 (JP) 2025-070271

(51) Int. Cl. H04N 23/55; G03B 29/00; G08B 13/196; H04N 23/51; H04N 23/56

(52) U.S. Cl. CPC H04N 23/55; G03B 29/00; G08B 13/19632; H04N 23/51; H04N 23/56

(57) ABSTRACT

An imaging device includes a camera, an illuminator including at least a part of an imaging range of the camera in an irradiation range, a casing including an opening part configured to be attached facing an indoor surface of a window and holding the camera and the illuminator such that an optical axis of the camera and an optical axis of the illuminator are directed toward the opening part, and a light shield including a surface extending in the direction of the optical axis of the camera between the camera and the illuminator. The light shield is achieved by one end facing the opening part.

### CROSS REFERENCE TO RELATED APPLICATIONS

This application claims priority benefit of Japanese Patent Application No. 2025-070271 filed on Apr. 22, 2025. The above-referenced application is hereby incorporated herein by reference in its entirety.

### TECHNICAL FIELD

The present invention relates to an imaging device and a monitoring device.

### BACKGROUND ART

Conventionally, a window camera capturing an image of the outside from an indoor surface of a window as described in Patent Document 1 has been proposed. For example, Patent Document 1 discloses a window camera including an imaging unit capturing an image of the outside from an indoor surface of a window, a casing including a rectangular attachment surface opposed to the indoor surface in parallel, where the imaging unit is provided in a recessed manner at the attachment surface, and is disposed such that an optical axis of the imaging unit coincides with an intersection of a pair of diagonal lines at the attachment surface, and a light shielding member formed of an elastic material, formed in a rectangular frame shape along an outer shape of the attachment surface by protruding from the attachment surface toward the indoor surface, and closing a gap between the indoor surface and the attachment surface by being elastically deformed by pressing from the casing.

### CITATION LIST

### Patent Literature

PTL 1: JP 2021-111812 A

### SUMMARY OF INVENTION

### Technical Problem

However, when a window camera is installed at an indoor surface of a window and captures an image of the outside from the indoor surface of the window, reflection light generated by reflection of light emitted from the inside of the room by a window glass or sunlight incident from the outside is incident on the camera, and thus the quality of a captured image captured by the camera is deteriorated.

The present invention has been made in view of the above problems, and an object of the present invention is to provide an imaging device suppressing glare due to reflection of indoor light at a window glass.

### Solution to Problem

An imaging device according to a representative embodiment of the present invention includes a camera, an irradiation unit including at least a part of an imaging range of the camera in an irradiation range, a casing including an opening part configured to be attached facing an indoor surface of a window, and holding the camera and the irradiation unit such that an optical axis of the camera and an optical axis of the irradiation unit are directed toward the opening part, and a light shielding unit including a surface extending in a direction of the optical axis of the camera between the camera and the irradiation unit, where one end of the light shielding unit faces the opening part.

### Advantageous Effects of Invention

According to one aspect of the present invention, an imaging device suppressing glare due to reflection of indoor light at a window glass can be achieved.

### BRIEF DESCRIPTION OF DRAWINGS

FIG. 1 is a diagram illustrating an example when a monitoring device according to an embodiment is installed indoors.

FIG. 2 is a rear view of the monitoring device according to the embodiment.

FIG. 3 is a rear view of an imaging device according to the embodiment.

FIG. 4 is a rear view of a mounting unit according to the embodiment.

FIG. 5 is a side view of the imaging device according to the embodiment when installed indoors.

FIG. 6 is a diagram illustrating a relationship between an imaging range and an irradiation range of the monitoring device according to the embodiment.

FIG. 7 is a diagram illustrating a relationship between irradiation light and reflection light in the imaging device when a light shielding unit is not provided.

FIG. 8 is a diagram illustrating a relationship between irradiation light, reflection light, and sunlight in the imaging device according to the embodiment.

FIG. 9 is a diagram illustrating a detailed configuration of a camera.

FIG. 10 is a diagram illustrating a configuration of a camera when an imaging unit substrate different from an imaging unit substrate in FIG. 9 is applied.

### DESCRIPTION OF EMBODIMENTS

### 1. Overview of Embodiment

First, an outline of a representative embodiment of the invention disclosed in the present application will be described. Note that, in the following description, as an example, reference signs in the drawings corresponding to the components of the invention are described in parentheses.

[1] An imaging device (10) according to a representative embodiment of the present invention includes a camera (13), an irradiation unit (14) including at least a part of an imaging range (AOV) of the camera (13) in an irradiating range (IA), a casing (11) including an opening part (112) configured to be attached facing an indoor surface (200I) of a window (200) and holding the camera (13) and the irradiation unit (14) such that an optical axis (13OA) of the camera (13) and an optical axis (14OA) of the irradiation unit (14) are directed toward the opening part (112), and a light shielding unit (12) including a surface extending in a direction of the optical axis (13OA) of the camera (13) between the camera (13) and the irradiation unit (14), and one end of the light shielding unit (12) faces the opening part (112).

[2] In the imaging device (10) according to [1], the light shielding unit (12) may be provided to abut on the indoor surface (200I) in a state where the opening part (112) is attached to the indoor surface (200I).

[3] In the imaging device (10) according to [1] or [2], the light shielding unit (12) may be provided to abut on an indoor surface (210I) of a window glass (210) of the window (200) in a state where the opening part (112) is attached to the indoor surface (200I).

[4] In the imaging device (10) according to any one of [1] to [3], the light shielding unit (12) may include vertical parts (121V, 122V) formed to extend substantially parallel to the indoor surfaces (200I, 210I) and horizontal parts (121H, 122H) formed to extend in a direction substantially perpendicular to the vertical parts (121V, 122V), and a surface (121V) opposed to the indoor surfaces (200I, 210I) among the vertical parts (121V, 122V) may include a light shielding material (121), and the horizontal parts (121H, 122H) may be located between the camera (13) and the irradiation unit (14).

[5] In the imaging device (10) according to any one of [1] to [4], a surface (121H) opposed to a side surface of the camera (13) among the horizontal parts (121H, 122H) may include the light shielding material (121).

[6] In the imaging device (10) according to any one of [1] to [5], the camera (13) may be a camera module and include an imaging unit (131), an imaging range adjustment unit (132) adjusting the imaging range (AOV) of the imaging unit (131), and a bracket (133) connected to the casing (11), the irradiation unit (14) may be an illumination module and include a light source (141) and an irradiation range adjustment unit (143) configured to adjust the irradiation range (IA) of the irradiation unit (14), the bracket (133) may connect the imaging range adjustment unit (132), the imaging range adjustment unit (132) may connect the imaging unit (131), and the imaging range adjustment unit (132) and the irradiation range adjustment unit (143) may be adjusted independently of or in conjunction with each other.

[7] The imaging device (10) according to any one of [1] to [6] may further include a power supply unit (17) receiving power from the outside and supplying power to the camera (13) and the irradiation unit (14), and the power input from the power supply unit (17) to the irradiation unit (14) may be equal to or less than 0.5 W.

[8] In the imaging device (10) according to any one of [1] to [7], the casing (11) may include a wire insertion part (113) where a wire is inserted.

[9] The imaging device (10) according to any one of [1] to [8] may further include a communication unit (19) transmitting data captured by the camera (13) to an external information processing device.

[10] The imaging device (10) according to [1] to [8] may further include a human sensor (181) stored in the casing (11), and a sound emission unit (182) stored in the casing (11) and outputting a warning sound based on information acquired by the human sensor (181), and the irradiation unit (14) may blink based on the information acquired by the human sensor (181).

[11] In the imaging device (10) according to [10], the human sensor (181) may be a millimeter wave radar sensor.

[12] A monitoring device (100) according to a representative embodiment of the present invention includes the imaging device (10) according to any one of [1] to [11], and an attachment part (20) attachable to the window (200), and the attachment part (20) includes an attachment/detachment mechanism (23) attaching/detaching the imaging device (10) by moving the imaging device (10) in a direction parallel to the indoor surfaces (200I, 210I).

### 2. Specific Examples of Embodiment

Specific examples of embodiments of the present invention will be described below with reference to the drawings. In the following description, components common to the respective embodiments are denoted by the same reference signs, and repeated descriptions thereof are omitted. The drawings are schematic drawings and the dimensional relationships, proportions, and the like between elements in the drawings may differ from reality. Some of the parts may be different in dimensional relationship and ratio in different drawings.

First, an environment where the monitoring device 100 is installed will be described.

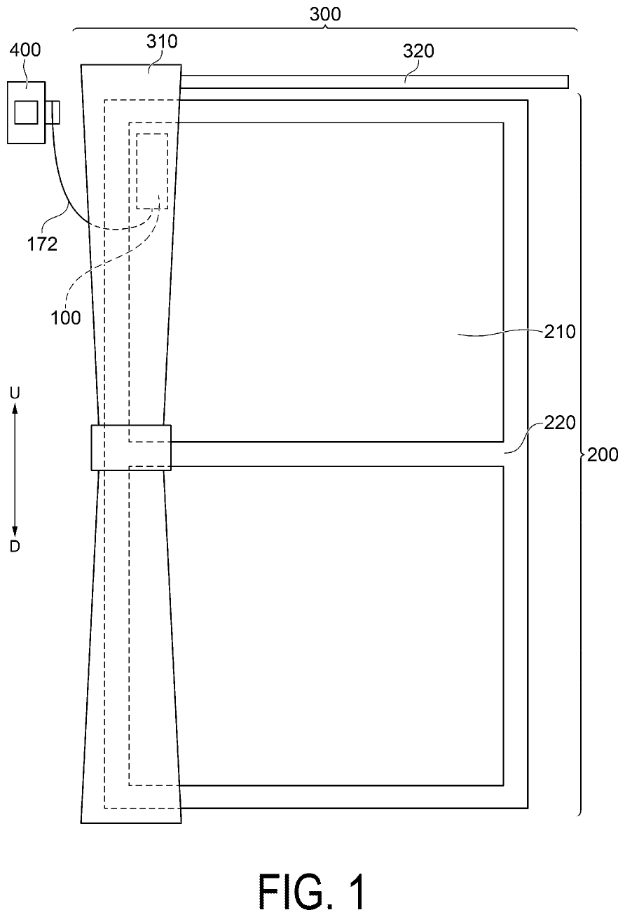

FIG. 1 is a diagram illustrating an example when a monitoring device according to an embodiment is installed indoors.

The monitoring device 100 according to the present embodiment is installed inside a building and monitors the outside of the building from the inside of the building for the purpose of crime prevention.

As illustrated in FIG. 1, the monitoring device 100 is installed at the indoor surface 200I of the window 200.

Note that, in the present embodiment, for convenience of description, a direction where the window 200 and the curtain rail 320 are arranged side by side is referred to as a vertical direction (arrow UD).

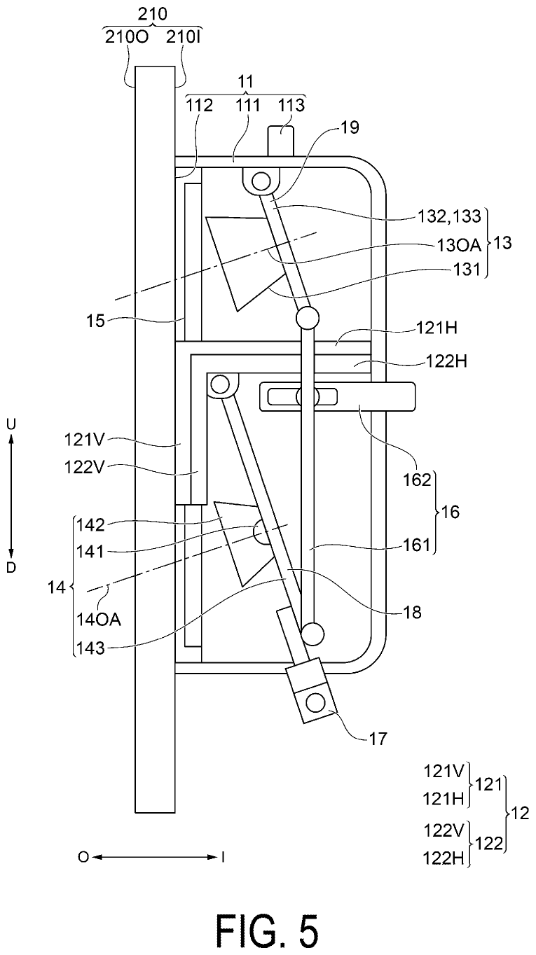

As illustrated in FIG. 5, a direction intersecting the vertical direction (arrow UD) is defined as a lateral direction indicated by an arrow IO. In the lateral direction (arrow IO), for example, the side where the shielding device 300 is installed is defined as an indoor side (arrow I), and the side opposite to the indoor side is defined as an outdoor side (arrow O).

The window 200 is a fitting installed at a wall of the building for the purpose of daylighting, ventilation, a view, and the like.

Note that the window 200 may be a double window.

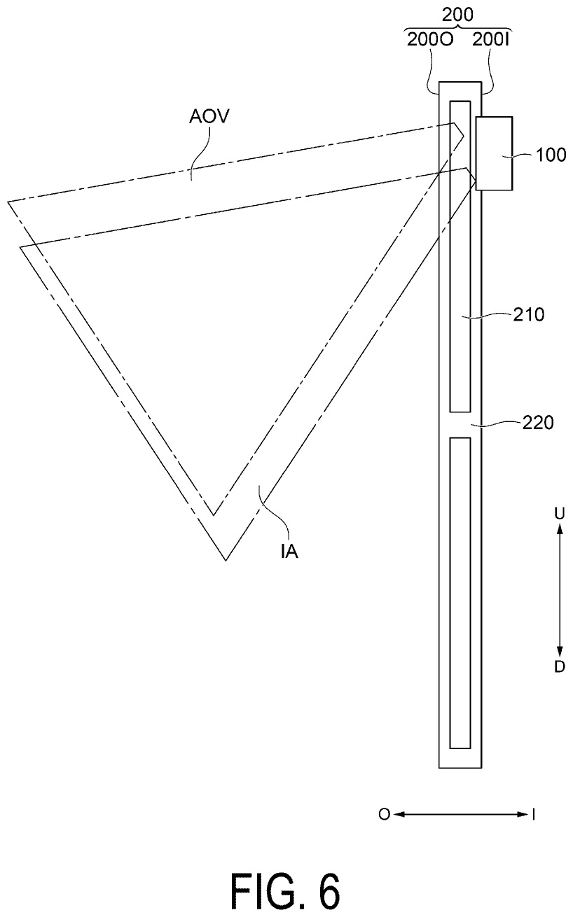

The indoor surface 200I of the window 200 faces the inside (indoors) of the building (see FIG. 6). A shielding device 300 is installed near the indoor surface 200I of the window 200.

An outdoor surface 200O of the window 200 faces the outside (outdoors) of the building (see FIG. 6).

The window 200 includes the window glass 210 and a window frame 220.

The window glass 210 is a transparent member installed at the window 200 for the purpose of daylighting, viewing, and the like. The window glass 210 is fitted into the window frame 220.

Note that the window glass 210 may be any of single glass, double glass, and triple glass.

The indoor surface 210I of the window glass 210 faces the inside (indoors) of the building (see FIG. 5). The shielding device 300 is installed in the vicinity of the indoor surface 210I of the window glass 210.

The outdoor surface 210O of the window glass 210 faces the outside (outdoors) of the building (see FIG. 5).

The window frame 220 is a tool for attaching the window 200 to a wall. The window glass 210 is fitted into the window frame 220.

The shielding device 300 is a device for adjusting daylighting and securing indoor privacy, such as a curtain.

The shielding device 300 includes a curtain 310 and the curtain rail 320.

The curtain 310 is a screen installed in the vicinity of the indoor surface 200I of the window 200 for the purpose of light shielding, sound insulation, partitioning, peep prevention, and the like. The curtain 310 is attached to the curtain rail 320.

The curtain rail 320 is installed above (arrow U) of the window 200, and is a tool for suspending the curtain 310.

The curtain 310 is deployed or folded in the direction where the curtain rail 320 extends.

The monitoring device 100 may be installed at any position of the indoor surface 200I of the window 200. However, in order to improve the indoor aesthetic appearance, the monitoring device 100 may be located between the window 200 and the curtain 310 in the lateral direction (arrow IO) when the curtain 310 is folded.

The monitoring device 100 receives power supplied from an outlet 400 through a cable 172.

The outlet 400 is installed, for example, in the vicinity of the curtain rail 320.

The outlet 400 can supply power to the monitoring device 100 and an electrical device such as an air conditioner (not illustrated) at the same time by connecting a power plug, for example.

Next, a detailed configuration of the monitoring device 100 will be described.

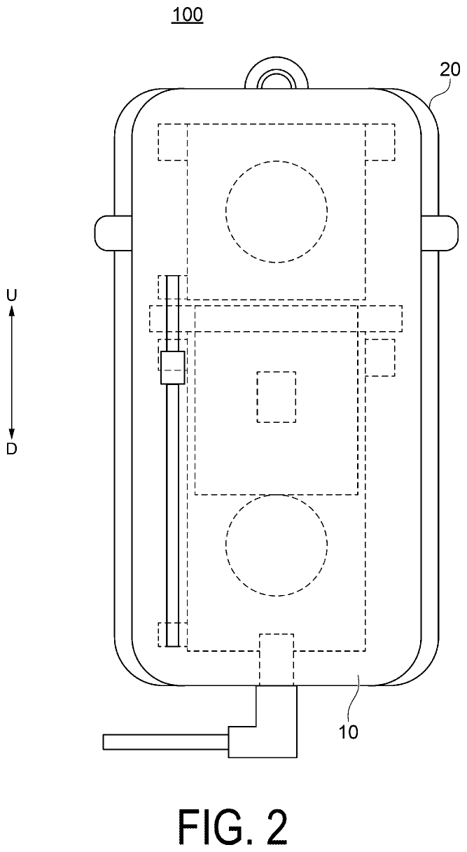

FIG. 2 is a rear view of a monitoring device according to the embodiment.

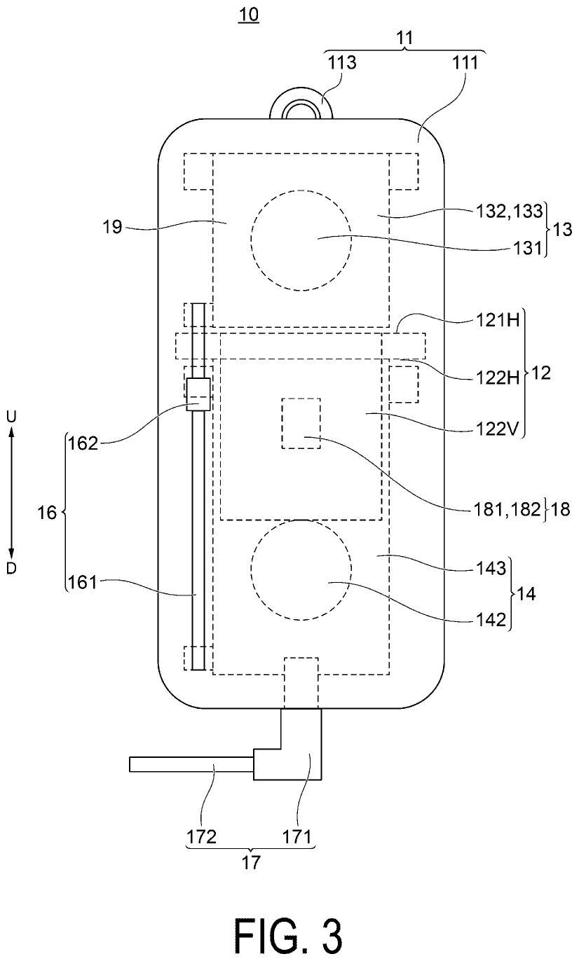

FIG. 3 is a rear view of an imaging device according to the embodiment.

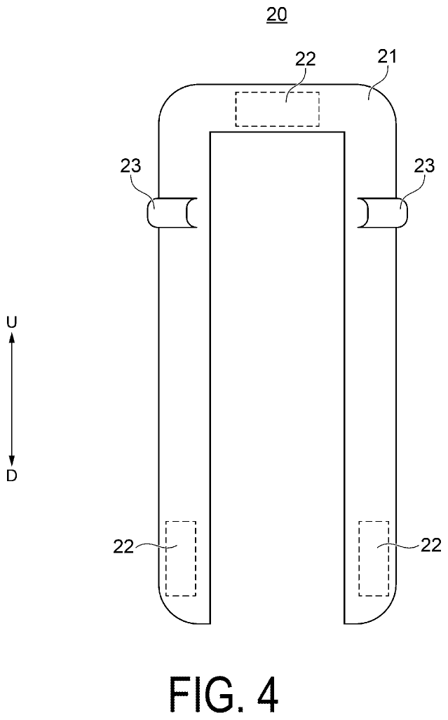

FIG. 4 is a rear view of an attachment portion according to the embodiment.

FIG. 5 is a side view of the imaging device according to the embodiment when installed indoors.

FIG. 6 is a diagram illustrating a relationship between an imaging range and an irradiation range of the monitoring device according to the embodiment.

As illustrated in FIG. 2, the monitoring device 100 includes the imaging device 10 and the attachment part 20.

The imaging device 10 is a device for monitoring the outside from the inside of a building.

As illustrated in FIGS. 3 and 5, the imaging device 10 includes the casing 11, the light shielding unit 12, the camera 13, the irradiation unit 14, the pedestal part 15, an angle adjustment unit 16, a power supply unit 17, a monitoring unit 18, and a communication unit 19.

The casing 11 is a member holding the light shielding unit 12, the camera 13, the irradiation unit 14, a pedestal part 15, the angle adjustment unit 16, the power supply unit 17, the monitoring unit 18, and the communication unit 19.

The casing 11 holds the camera 13 and the irradiation unit 14 such that the optical axis 13OA (see FIG. 5) of the camera 13 and the optical axis 14OA (see FIG. 5) of the irradiation unit 14 are directed toward the opening part 112.

The casing 11 includes a main body part 111, the opening part 112, and the wire insertion part 113.

The main body part 111 has a substantially rectangular parallelepiped shape and has the opening part 112 at the surface at the outdoor side (arrow O).

The light shielding unit 12, the camera 13, the irradiation unit 14, the pedestal part 15, the angle adjustment unit 16, the monitoring unit 18, and the communication unit 19 are stored inside the main body part 111.

An insertion port for connecting a terminal 171 of the power supply unit 17 is provided at the lower side (arrow D) of the main body part 111.

The opening part 112 is a part provided at the surface of the main body part 111 at the outdoor side (arrow O), and is opposed to the indoor surface 200I of the window 200.

The wire insertion part 113 is a part provided at the upper side (arrow U) of the main body part 111 and having a hole where a wire is inserted.

The wire inserted through the wire insertion part 113 is fixed at, for example, the curtain rail 320, and prevents the monitoring device 100 from falling.

The light shielding unit 12 has an L-shaped flat plate shape in a side view, and includes the light shielding material 121 and the light shielding material pedestal 122.

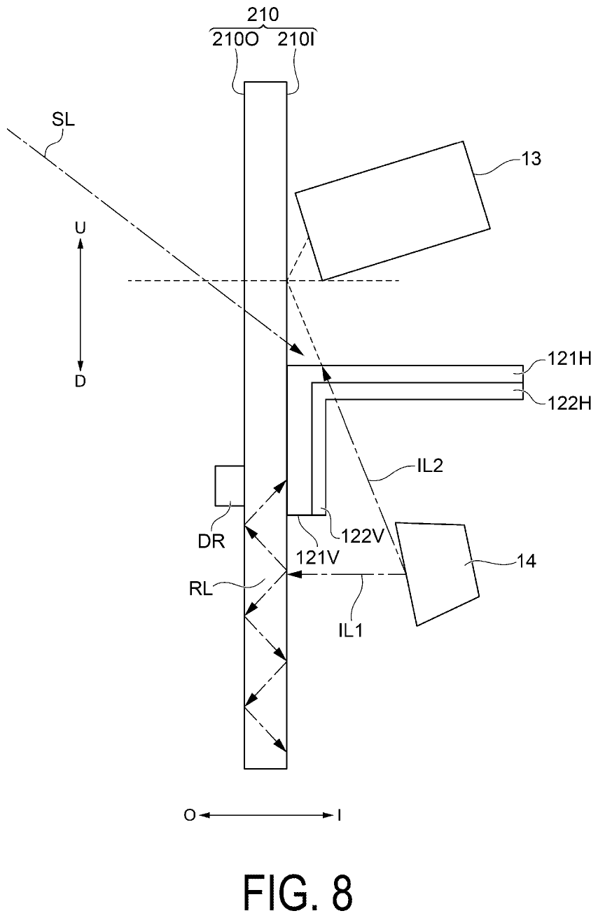

The light shielding material 121 is a member for shielding reflection light generated by reflection of light emitted by the irradiation unit 14 by the window glass 210 and sunlight SL (see FIG. 8) from being incident on the camera 13.

The light shielding material 121 includes the vertical part 121V formed to extend in parallel or substantially in parallel with the indoor surface 200I, and the horizontal part 121H formed to extend in a direction perpendicular or substantially perpendicular to the vertical part 121V.

The horizontal part 121H is a part located between the camera 13 and the irradiation unit 14 in the vertical direction (arrow UD) and extending in the direction of the optical axis 13OA of the camera 13.

The horizontal part 121H has a surface opposed to the side surface of the camera 13, and is made of a light shielding material.

The vertical part 121V is provided to abut on the indoor surface 200I in a state where the opening part 112 is attached to the indoor surface 200I. The vertical part 121V is provided to abut on the indoor surface 210I of the window glass 210 in a state where the opening part 112 is attached to the indoor surface 200I.

The vertical part 121V has a surface opposed to the indoor surface 200I and is made of a light shielding material.

The light shielding material pedestal 122 is a member for supporting the light shielding material 121.

The light shielding material pedestal 122 includes the vertical part 122V formed to extend in parallel or substantially in parallel with the indoor surface 200I, and the horizontal part 122H formed to extend in a direction perpendicular or substantially perpendicular from the vertical part 122V. Note that the shape of the light shielding material pedestal 122 is not limited to the shape illustrated in the present embodiment as long as the light shielding material pedestal can support the light shielding material 121.

The horizontal part 122H is a part located between the camera 13 and the irradiation unit 14 in the vertical direction (arrow UD) and extending in the direction of the optical axis 13OA of the camera 13.

The horizontal part 122H is located at the lower side (arrow D) of the horizontal part 121H.

The vertical part 122V is located at the indoor side (arrow I) with respect to the vertical part 121V.

The camera 13 is a member for monitoring the outside of the building from the inside of the building.

In the present embodiment, the camera 13 is a camera module where an image sensor, a lens, an image processing circuit, and the like are integrally formed.

The camera 13 is located at the upper side (arrow U) of the light shielding unit 12 in the vertical direction (arrow UD).

The camera 13 includes the imaging unit 131, the imaging range adjustment unit 132, and the bracket 133.

The optical axis 13OA is an optical center axis passing through the centers of the lens and the image circle of the imaging unit 131. The direction of the optical axis 13OA is adjusted by the imaging range adjustment unit 132.

The imaging unit 131 is a functional unit including an image sensor, a lens, an image processing circuit, and the like. The imaging unit 131 is held by the bracket 133 such that the imaging range AOV is developed toward the outdoor side (arrow O).

The imaging range adjustment unit 132 is a functional unit adjusting the imaging range AOV of the imaging unit 131. The imaging range adjustment unit 132 is connected to the imaging unit 131 via the bracket 133.

The imaging range adjustment unit 132 can adjust the imaging range AOV independently, but can also adjust the imaging range AOV in conjunction with the irradiation range adjustment unit 143.

The bracket 133 is a member coupling the imaging unit 131 and the imaging range adjustment unit 132.

The bracket 133 is connected to the casing 11 and the angle adjustment unit 16. The bracket 133 connects the imaging range adjustment unit 132.

The irradiation unit 14 is a member irradiating the imaging range AOV of the camera 13 with light and maintaining the quality of the captured image captured by the camera 13.

In the present embodiment, the irradiation unit 14 is an illumination module where the light source 141, a control circuit, and the like are integrally formed.

The irradiation unit 14 is located at the lower side (arrow D) of the light shielding unit 12 in the vertical direction (arrow UD).

The irradiation unit 14 includes the light source 141, a lens 142, and the irradiation range adjustment unit 143.

The optical axis 14OA is an optical center axis passing through the center of light emitted from the light source 141. The direction of the optical axis 13OA is adjusted by the irradiation range adjustment unit 143.

The light source 141 is a light emitter outputting light to be irradiated to the imaging range AOV of the camera 13.

In the present embodiment, the light source 141 is a visible light LED (LIGHT EMITTING DIODE), but is not limited to the visible light LED as long as the light source has a wavelength easily transmitted through glass, and may be, for example, an OLED (ORGANIC LIGHT EMITTING DIODE), an HID (HIGH INTENSITY DISCHARGE) lamp, or a laser light source. Note that, since infrared rays are reflected by glass and are not easily transmitted, an infrared LED is not preferable.

The lens 142 is a member refracting the light output from the light source 141 to adjust the irradiation state.

The irradiation range adjustment unit 143 is a functional unit adjusting the irradiation range IA of the irradiation unit 14.

The irradiation range adjustment unit 143 includes a circuit board, and connects the light source 141 and the lens 142.

The irradiation range adjustment unit 143 can adjust the irradiation range IA independently, but can also adjust the irradiation range IA in conjunction with the imaging range adjustment unit 132.

As illustrated in FIG. 6, the irradiation range IA of the light irradiated by the irradiation unit 14 includes at least a part of the imaging range AOV of the camera 13.

The pedestal part 15 is provided in the vicinity of the opening part 112, and is a member for supporting the light shielding material pedestal 122.

The angle adjustment unit 16 is a member for adjusting the imaging range AOV of the camera 13.

The angle adjustment unit 16 includes a link 161 and an angle adjustment lever 162.

A link 161 is a member formed to extend along the vertical direction (arrow UD).

The link 161 includes a protrusion part for connecting with the angle adjustment lever 162 in a direction along the opening part 112 or the indoor surface 200I of the window 200.

The imaging range adjustment unit 132 is connected to the upper side (arrow U) of the link 161.

The irradiation range adjustment unit 143 is connected to the lower side (arrow D) of the link 161.

The angle adjustment lever 162 is a member formed to extend along the lateral direction (arrow IO), and a long hole for connecting the link 161 is formed to extend in the lateral direction (arrow IO).

The angle adjustment lever 162 moves in parallel along the lateral direction (arrow IO), and adjusts the angle of the link 161 with respect to the opening part 112 or the indoor surface 200I of the window 200.

The power supply unit 17 is a functional unit receiving power from the outside and supplying power to the camera 13 and the irradiation unit 14.

The power supply unit 17 includes a terminal 171 and a cable 172.

Note that the power input from the power supply unit 17 to the irradiation unit 14 is usually adjusted to be equal to or less than 0.5 W.

However, when the camera 13 or the monitoring unit 18 detects that a person is present in the imaging range AOV, the monitoring device 100 can increase the power input from the power supply unit 17 to the irradiation unit 14.

For example, when the camera 13 or the monitoring unit 18 detects that a person is present outdoors, the monitoring device 100 can cause the irradiation unit 14 to blink by switching the power input from the power supply unit 17 to the irradiation unit 14 between a value equal to or less than 0.5 W and a value exceeding 0.5 W in a short time.

The terminal 171 is a member receiving power supplied from the outlet 400 and supplying power to the camera 13 and the irradiation unit 14.

In the present embodiment, the insertion ports of the terminal 171 and the main body part 111 have shapes conforming to the USB (UNIVERSAL SERIAL BUS) standard, but the shapes are not limited to the shapes, and any shape can be adopted.

The cable 172 is a member for supplying power supplied from the outlet 400 to the camera 13 and the irradiation unit 14. The cable 172 includes an adapter (not illustrated) and is connected to the outlet 400 via the adapter.

The monitoring unit 18 is a functional unit detecting the presence of a person outdoors and outputting a warning sound.

The monitoring unit 18 includes the human sensor 181 and the sound emission unit 182.

The human sensor 181 is a detector stored in the casing 11 and detecting a person or an animal within a detection range by a millimeter wave radar or the like. For example, when a millimeter wave radar is adopted as the human sensor 181, the millimeter wave is suitable for detecting a person or an animal through the window glass 210 since the millimeter wave has a short wavelength. For example, it is possible to more reliably detect a person or an animal without depending on image recognition of the camera 13.

The human sensor 181 is attached to, for example, a circuit board included in the irradiation range adjustment unit 143, but can be attached to any position as long as the position is inside or around the casing 11.

The sound emission unit 182 is a functional unit stored in the casing 11 and outputting a warning sound based on information acquired by the human sensor 181.

The sound emission unit 182 is attached to, for example, a circuit board included in the irradiation range adjustment unit 143, but can be attached to any position as long as the position is inside or around the casing 11.

The communication unit 19 is a functional unit transmitting data captured by the camera 13 to an external information processing device.

The communication unit 19 can transmit, for example, data captured by the camera 13 to an external information processing device through wireless communication.

The attachment part 20 is a device attached to the window 200 and holding the imaging device 10. To be specific, the attachment part 20 is attached to the indoor surface 210I of the window glass 210 to hold the imaging device 10.

As illustrated in FIG. 4, the attachment part 20 includes an attachment bracket 21, a double-sided tape 22, and the attachment/detachment mechanism 23.

The attachment bracket 21 is a member made of resin (for example, vinyl chloride resin) having a U-shaped (C-shaped) flat plate shape in a rear view and having a shape corresponding to the opening part 112 of the casing 11. By adopting the above-described shapes and materials, the attachment bracket 21 can be easily removed from the indoor surface 210I of the window glass 210, for example, when the user moves to another place.

In order to connect the casing 11 to the attachment bracket 21 while moving the casing 11 upward (arrow U) in parallel, a member extending along the indoor surface 200I of the window 200 is not attached to the lower side (arrow D) of the attachment bracket 21.

The double-sided tape 22 and the attachment/detachment mechanism 23 are attached to the attachment bracket 21.

The double-sided tape 22 is a member for sticking the attachment part 20 to the indoor surface 210I of the window glass 210.

The double-sided tape 22 can be attached to any position at the outdoor side (arrow O) of the attachment bracket 21.

In the present embodiment, the double-sided tape 22 is attached to the attachment bracket 21 at one position at the upper side (arrow U) and at two positions at the lower side (arrow D).

The attachment/detachment mechanism 23 is a mechanism attaching/detaching the imaging device 10 to/from the attachment bracket 21 by moving the imaging device 10 in a direction parallel to the indoor surface 200I to engage/disengage the imaging device 10.

Next, a mechanism of shielding light deteriorating the quality of the captured image captured by the camera 13 by the light shielding unit 12 will be described.

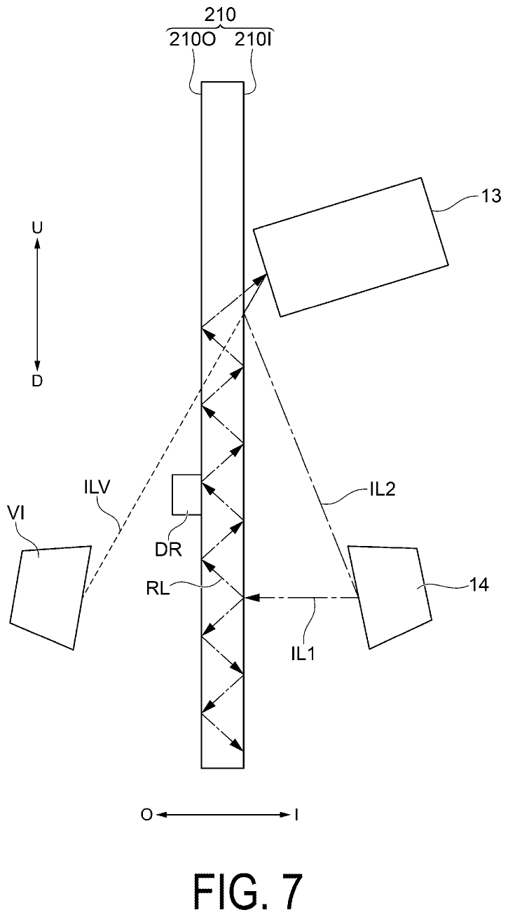

FIG. 7 is a diagram illustrating a relationship between irradiation light and reflection light in an imaging device when there is no light shielding portion.

FIG. 8 is a diagram illustrating a relationship between irradiation light, reflection light, and sunlight in the imaging device according to the embodiment.

In FIG. 7, the camera 13 is provided at the upper side (arrow U) of the indoor side (arrow I) of the window glass 210, and the irradiation unit 14 is provided at the lower side (arrow D).

In FIG. 7, dirt DR adheres to the outdoor surface 210O of the window glass 210.

Here, when the light source 141 of the irradiation unit 14 outputs light, irradiation light IL1 and IL2 is irradiated toward the outdoor side (arrow O).

At this time, the irradiation light IL1 incident on the indoor surface 210I of the window glass 210 generates specular reflection light RL inside the window glass 210.

Reflected light RL travels in the vertical direction (arrow UD) while repeating reflection inside the window glass 210, and enters the imaging range AOV of the camera 13.

The irradiation light IL2 incident on the indoor surface 210I of the window glass 210 toward the upper side (arrow U) is reflected by the indoor surface 210I of the window glass 210 and enters the imaging range AOV of the camera 13.

The irradiation light IL1 and IL2 generates a virtual image VI of the irradiation unit 14 at the outdoor side (arrow O) of the window glass 210.

Irradiation light ILV of the virtual image generated by the virtual image VI travels from the outdoor side (arrow O) of the window glass 210 to the indoor side (arrow I) of the window glass 210, and enters the imaging range AOV of the camera 13.

The reflection light RL and irradiation light ILV of the virtual image are further reflected by the dirt DR.

The reflection light RL and the irradiation light ILV of the virtual image deteriorate the quality of the captured image captured by the camera 13.

Therefore, as illustrated in FIG. 8, by providing the light shielding unit 12 between the camera 13 and the irradiation unit 14 in the vertical direction (arrow UD), it is possible to suppress glare due to the reflection at the window glass 210 and to prevent the deterioration of the quality of the captured image of the camera 13.

To be more specific, the imaging device 10 can shield the reflection light RL generated by the irradiation light IL1 by the vertical part 121V of the light shielding material 121 abutting on the indoor surface 200I of the window 200. The imaging device 10 can further shield the reflection light RL generated by the irradiation light IL1 by the vertical part 121V of the light shielding material 121 abutting on the indoor surface 210I of the window glass 210 of the window 200.

That is, the vertical part 121V shields the reflection light RL traveling upward (arrow U) while repeating reflection, and prevents the reflection light RL from entering further upward (arrow U).

The vertical part 121V or the horizontal part 121H of the light shielding material 121 prevents the irradiation light IL2 from entering the imaging range AOV of the camera 13, and prevents the virtual image VI of the irradiation unit 14 from being generated.

The horizontal part 121H of the light shielding material 121 shields reflection of sunlight SL entering from the outdoor side (arrow O) of the window glass 210 to the indoor side (arrow I) of the window glass 210.

As described above, by providing the light shielding unit 12 between the camera 13 and the irradiation unit 14 in the vertical direction (arrow UD), it is possible to prevent the deterioration of the quality of the captured image of the camera 13 due to the sunlight SL in addition to the reflection light RL generated by the irradiation light IL1 and IL2 and the virtual image VI of the irradiation unit 14.

Next, a detailed configuration of the imaging unit of the camera will be described.

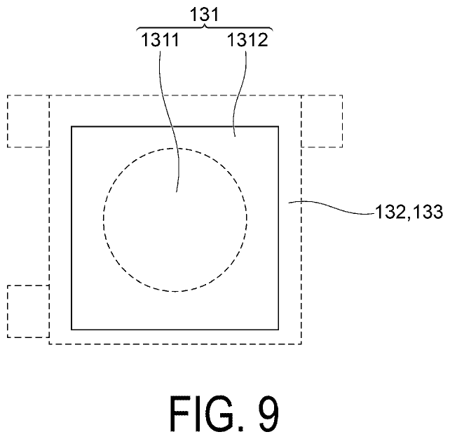

FIG. 9 is a diagram illustrating a detailed configuration of the camera.

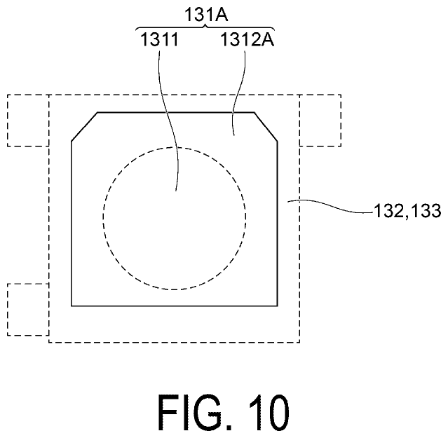

FIG. 10 is a diagram illustrating a configuration of the camera when an imaging unit substrate different from the imaging unit substrate in FIG. 9 is applied.

As illustrated in FIG. 9, the imaging unit 131 of the camera 13 includes an imaging unit lens 1311 and an imaging unit substrate 1312.

The imaging unit lens 1311 is a member adjusting the focus of the captured image captured by the imaging unit 131.

The imaging unit substrate 1312 is a circuit board including an image sensor, an image processing circuit, and the like.

The imaging unit substrate 1312 in FIG. 9 has a substantially rectangular shape.

The imaging unit substrate 1312 may have, for example, a shape of an imaging unit substrate 1312A illustrated in FIG. 10, in addition to the shape illustrated in FIG. 9.

That is, an imaging unit 131A of a camera 13A illustrated in FIG. 10 includes the imaging unit substrate 1312A different from the imaging unit substrate 1312 of the camera 13.

Unlike the imaging unit substrate 1312, the imaging unit substrate 1312A is chamfered at the upper side (arrow U) of the substrate.

The position of the imaging unit lens 1311 attached to the imaging unit substrate 1312 is different from the position of the imaging unit lens 1311 attached to the imaging unit substrate 1312A.

The bracket 133 according to the present embodiment has a shape capable of coupling any of the imaging unit substrate 1312 and the imaging unit substrate 1312A having different shapes described above.

Accordingly, even in a case of the imaging unit 131 having a different shape, the bracket 133 can incorporate the imaging units 131 and 131A into the cameras 13 and 13A without changing the shape of the imaging unit 131 itself.

As described above, the imaging device 10 according to the present embodiment includes the camera 13, the irradiation unit 14 including at least a part of the imaging range AOV of the camera 13 in the irradiation range IA, the casing 11 including the opening part 112 attachable opposed to the indoor surface 200I of the window 200 and holding the camera 13 and the irradiation unit 14 such that the optical axis 13OA of the camera 13 and the optical axis 14OA of the irradiation unit 14 are directed toward the opening part 112, and the light shielding unit 12 including a surface extending in the direction of the optical axis 13OA of the camera 13 between the camera 13 and the irradiation unit 14. One end of the light shielding unit 12 faces the opening part 112.

Accordingly, the imaging device 10 installed inside the building and monitoring outdoors is located between the camera 13 and the irradiation unit 14, and includes the light shielding unit 12 having one end opposed to the indoor surface 210I of the window glass 210, such that it is possible to shield the incidence of the reflection light RL generated by the irradiation light IL1 and IL2, the virtual image VI of the irradiation unit 14, and the sunlight SL on the imaging range AOV of the camera 13.

Therefore, according to the imaging device 10 of the present embodiment, it is possible to suppress the glare of the indoor light due to the reflection at the window glass.

The light shielding unit 12 of the imaging device 10 is provided to abut on the indoor surface 200I in a state where the opening part 112 is attached to the indoor surface 200I.

Accordingly, it is possible to more reliably shield the reflection light RL generated by the irradiation light IL1 and IL2 from being incident on the imaging range AOV of the camera 13.

The light shielding part 12 is provided to abut on the indoor surface 210I of the window glass 210 of the window 200 in a state where the opening part 112 is attached to the indoor surface 200I.

Accordingly, it is possible to more reliably shield the reflection light RL generated by the irradiation light IL1 and IL2 from being incident on the imaging range AOV of the camera 13.

The light shielding unit 12 of the imaging device 10 includes the vertical parts 121V and 122V formed to extend substantially parallel to the indoor surface 200I, and the horizontal parts 121H and 122H formed to extend in a direction substantially perpendicular to the vertical parts 121V and 122V. The surface 121V opposed to the indoor surface 200I among the vertical parts 121V and 122V includes the light shielding material 121, and the horizontal parts 121H and 122H are located between the camera 13 and the irradiation unit 14.

Accordingly, the vertical part 121V can shield the reflection light RL generated by the irradiation light IL1 and traveling upward (arrow U) while repeating reflection.

The vertical part 121V or the horizontal part 121H can shield the irradiation light IL2 incident on the indoor surface 210I of the window glass 210 toward the upper side (arrow U).

The horizontal part 121H can shield reflection of the sunlight SL.

The surface 121H opposed to the side surface of the camera 13 among the horizontal parts 121H and 122H of the imaging device 10 includes the light shielding material 121.

Accordingly, the horizontal part 121H shields reflection of the sunlight SL, and prevents the decrease in the luminance of the light irradiated by the irradiation unit 14 in the irradiation range IA, thereby preventing the deterioration of the quality of the image captured by the camera 13.

The camera 13 of the imaging device 10 is a camera module and includes the imaging unit 131, the imaging range adjustment unit 132 adjusting the imaging range AOV of the imaging unit 131, and the bracket 133 connected to the casing 11. The irradiation unit 14 is an illumination module and includes the light source 141 and the irradiation range adjustment unit 143 adjusting the irradiation range IA of the irradiation unit 14. The bracket 133 connects the imaging range adjustment unit 132. The imaging range adjustment unit 132 connects the imaging unit 131. The imaging range adjustment unit 132 and the irradiation range adjustment unit 143 are adjusted independently of or in conjunction with each other.

Accordingly, by adjusting the imaging range AOV of the imaging unit 131 and the irradiation range IA of the irradiation unit 14 independently of or in conjunction with each other, it is possible to enlarge the region of the captured image captured by the imaging unit 131.

The bracket 133 enables the imaging units 131 and 131A to be incorporated into the cameras 13 and 13A without changing the shape of the imaging unit 131 itself even in the case of the imaging unit 131 having a different shape.

The imaging device 10 includes the power supply unit 17 receiving power from the outside and supplying power to the camera 13 and the irradiation unit 14, and the power input from the power supply unit 17 to the irradiation unit 14 is equal to or less than 0.5 W.

Accordingly, the irradiation unit 14 can maintain the quality of the captured image of the camera 13 by setting the illumination of the irradiation light IL1 and IL2 irradiated by the irradiation unit 14 to a magnitude where the reflection light RL generated by the irradiation light IL1 and IL2 can be reliably shielded by the light shielding unit 12 while irradiating sufficient illumination to secure the quality of the captured image of the camera 13.

The casing 11 of the imaging device 10 includes a wire insertion part 113 through which a wire is inserted.

Accordingly, by inserting the wire through the wire insertion part 113 and binding the wire to the curtain rail 320, the imaging device 10 is suspended from the curtain rail 320, and thus it is possible to prevent the imaging device 10 from falling.

The imaging device 10 includes a communication unit 19 transmitting data captured by the camera 13 to an external information processing device.

Accordingly, it is possible to check data captured by the camera 13 at any time by the external information processing device, and to designate the imaging method of the camera 13 by the external information processing device.

The imaging device 10 includes the human sensor 181 stored in the casing 11 and the sound emission unit 182 stored in the casing 11 and outputting the warning sound based on the information acquired by the human sensor 181, and the irradiation unit 14 blinks based on the information acquired by the human sensor 181.

Accordingly, the human sensor 181 detects a person and an animal, the sound emission unit 182 outputs a warning sound, and the irradiation unit 14 blinks, such that the outdoor surface 200O of the window 200 can be monitored from the indoor surface 200I of the window 200 independently of the camera 13.

The human sensor 181 is a millimeter wave radar sensor.

Accordingly, a person or an animal can be detected through the window glass 210.

It is possible to more reliably detect a person or an animal without relying on the image recognition of the cameras 13 and 13A.

The monitoring device 100 according to the present embodiment includes the imaging device 10 and the attachment part 20 attachable to the window 200, and the attachment part 20 includes the attachment/detachment mechanism 23 attaching/detaching the imaging device 10 by moving the imaging device 10 in a direction parallel to the indoor surface 200I.

Accordingly, the monitoring device 100 can be easily attached to the window 200 by attaching the imaging device 10 to the attachment part 20 by the attachment/detachment mechanism 23 while moving the imaging device 10 in parallel and sticking the attachment part 20 to the indoor surface 210I of the window glass 210 by the double-sided tape 22.

### Expansion of Embodiment

The invention made by the present inventor has been specifically described above based on the embodiment, but the present invention is not limited to the embodiment, and it goes without saying that the present invention can be changed in various ways within the scope not departing from the gist of the present invention.

For example, in the above embodiment, the vertical part 121V of the light shielding material 121 abuts on the indoor surface 210I of the window glass 210, but the present invention is not limited to the configuration. For example, the vertical part 121V of the light shielding material 121 may be close to the indoor surface 200I of the window 200, and even if the vertical part 121V is not completely in contact with the indoor surface 210I of the window glass 210, it is possible to suppress glare due to reflection at the window glass 210 and prevent deterioration of the quality of the captured image of the camera 13.

The lower end of the vertical part 121V of the light shielding material 121 and the vertical part 122V of the light shielding material pedestal 122 at the lower side (arrow D) may reach the range of the illumination range IA of the irradiation unit 14 as long as sufficient illumination from the irradiation unit 14 for securing the quality of the captured image of the camera 13 can be secured.

That is, the lengths of the vertical part 121V of the light shielding material 121 and the vertical part 122V of the light shielding material pedestal 122 in the vertical direction (arrow UD) may have a certain degree of tolerance.

### REFERENCE SIGNS LIST

10. Imaging device, 11. Casing, 12. Light shielding unit, 13, 13A. Camera, 14. Irradiating unit, 15. Pedestal part, 16. Angle adjustment unit, 17. Power supply unit, 18. Monitoring unit, 19. Communication unit, 20. Attachment part, 21. Attachment bracket, 22. Double-sided tape, 23. Attachment/detachment mechanism, 100. Monitoring device, 111. Main body part, 112. Opening part, 113. Wire insertion part, 121. Light shielding material, 122. Light shielding material pedestal, 121H, 122H. Horizontal part, 121V, 122V. Vertical part, 13OA. Optical axis, 131. Imaging unit, 132. Imaging range adjustment unit, 133. Bracket, 14OA. Optical axis, 141. Light source, 142. Lens, 143. Irradiation range adjustment unit, 161. Link, 162. Angle adjustment lever, 171. Terminal, 172. Cable, 181. Human sensor, 182. Sound emission unit, 200. Window, 200I, 210I. Indoor surface, 200O, 210O. Outdoor surface, 210. Window glass, 220. Window frame, 300. Shielding device, 310. Curtain, 320. Curtain rail, 400. Outlet, 1311. Imaging unit lens, 1312, 1312A. Imaging unit substrate, AOV. Imaging range, DR. Dirt, IA. Irradiation range, IL1, IL2. Irradiation light, ILV. Irradiation light of virtual image, RL. Reflection light, SL. Sunlight, VI, Virtual image

1. An imaging device comprising:
a camera;
an illuminator including at least a part of an imaging range of the camera in an irradiation range;
a casing including an opening part configured to be attached facing an indoor surface of a window, and holding the camera and the illuminator such that an optical axis of the camera and an optical axis of the illuminator are directed toward the opening part; and
a light shield including a surface extending in a direction of the optical axis of the camera between the camera and the illuminator,
wherein one end of the light shield faces the opening part.

2. The imaging device according to claim 1,
wherein the light shield is provided to abut on the indoor surface in a state where the opening part is attached to the indoor surface.

3. The imaging device according to claim 1,
wherein the light shield is provided to abut on an indoor surface of a window glass of the window in a state where the opening part is attached to the indoor surface.

4. The imaging device according to claim 2,
wherein the light shield includes a vertical part formed to extend substantially parallel to the indoor surface, and a horizontal part formed to extend in a direction substantially perpendicular to the vertical part,
a surface of the vertical part opposed to the indoor surface includes a light shielding material, and
the horizontal part is located between the camera and the illuminator.

5. The imaging device according to claim 4,
wherein a surface of the horizontal part opposed to a side surface of the camera includes a light shielding material.

6. The imaging device according to claim 5,
wherein the camera is a camera module, and includes an imaging unit, an imaging range adjuster configured to adjust the imaging range of the imaging unit, and a bracket connected to the casing,
the illuminator is an illumination module, and includes a light source and an irradiation range adjuster configured to adjust the irradiation range of the illuminator,
the bracket is configured to connect the imaging range adjuster,
the imaging range adjuster is configured to connect the imaging unit, and
the imaging range adjuster and the irradiation range adjuster are adjusted independently of or in conjunction with each other.

7. The imaging device according to claim 6, further comprising a power supply configured to receive power from an outside and supply power to the camera and the illuminator,
wherein the power input from the power supply to the illuminator is equal to or less than 0.5 W.

8. The imaging device according to claim 6,
wherein the casing includes a wire insertion part where a wire is inserted.

9. The imaging device according to claim 6, further comprising a communication unit configured to transmit data captured by the camera to an external information processing device.

10. The imaging device according to claim 6, further comprising:
a human sensor stored in the casing; and
a sound emitter stored in the casing and configured to output a warning sound based on information acquired by the human sensor,
wherein the illuminator blinks based on the information acquired by the human sensor.

11. The imaging device according to claim 10,
wherein the human sensor is a millimeter wave radar sensor.

12. A monitoring device comprising:
the imaging device according to claim 4, and
an attachment part attachable to the window,
wherein the attachment part includes an attachment/detachment mechanism configured to attach/detach the imaging device by moving the imaging device in a direction parallel to the indoor surface.
